(19) United States
(12) Patent Application Publication
(10) Pub. No.: US 2025/0182050 A1
(43) Pub. Date: Jun. 5, 2025

(54) OPTIMIZED GEOGRAPHIC DISTRIBUTION BASED ON CURRENTLY UNAVAILABLE LOCATIONS

(71) Applicant: SAP SE, Walldorf (DE)

(72) Inventors: Anne DEMEL, Schwetzingen (DE); Berno KOFLER, Walldorf (DE)

(21) Appl. No.: 18/528,931

(22) Filed: Dec. 5, 2023

(51) Int. Cl. G06Q 10/0875

(52) U.S. Cl. CPC G06Q 10/0875

(57) ABSTRACT

Provided are systems and methods that can optimize replenishment operations within a distribution network. The system executes a replenishment sourcing process in the background of a website. When an order for a quantity of an object is received from a target location via a user interface of the website, the website selects a location to deliver the quantity of the object to the target location from those distribution centers that currently have enough quantity of the physical object to cover the order. Meanwhile, the background process determines whether the selected location is actually the best location when all distribution centers are considered, even those without enough current quantity of the physical object to cover the initial order. The determination can be used to modify replenishment within the distribution network.

### BACKGROUND

Optimization of stock levels at distribution centers (DCs) within a supply network can be a complex process. For example, when a customer orders a quantity of a product from the supply network, the supply network must select a distribution center within the supply network to fulfill the order. Often, the supply network will select an optimum distribution center with enough available product to fulfill the order and deliver the quantity to a location of the customer. There are multiple drawbacks with this process. For example, a distribution center that does not have enough product to fulfill the order is typically not considered for the optimal delivery location. This can result in a non-optimal distribution center becoming a permanent delivery location for the customer.

### BRIEF DESCRIPTION OF THE DRAWINGS

Features and advantages of the example embodiments, and the manner in which the same are accomplished, will become more readily apparent with reference to the following detailed description while taken in conjunction with the accompanying drawings.

FIG. 1A is a diagram illustrating a process of ordering a quantity of an object via a page of a website in accordance with an example embodiment.

FIG. 1B is a diagram illustrating a process of determining an optimal distribution center in a background in accordance with an example embodiment.

FIG. 1C is a diagram illustrating a process of replenishing a distribution center within the distribution network in accordance with an example embodiment.

FIGS. 2A-2F are diagrams illustrating a process of identifying an optimal distribution center and dispatching a quantity of goods to the optimal distribution center in accordance with example embodiments.

FIGS. 3A and 3B are diagrams illustrating a process of adjusting table data to identify the optimal distribution center within the supply network in accordance with an example embodiment.

FIG. 4 is a diagram illustrating a method of determining optimal fulfillment instructions based on background sourcing process in accordance with an example embodiment.

FIG. 5 is a diagram illustrating a computing system for use with any of the examples herein in accordance with an example embodiment

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Purchasing goods online often results in a quantity of goods being purchased by a customer and delivered to a target location, such as a customer's house or place of business. For larger e-commerce sites, there are often multiple distribution centers located in multiple different geographic areas that can fulfill the ordered quantity of goods. A distribution center is generally a physical facility with physical space to house/store physical goods such as products that are purchased online. A software application may figure out which distribution center to use for the delivery of the goods. Furthermore, in response to the quantity of goods leaving the distribution center, the software application may automatically trigger more quantity of the goods to be transported from a plant to the distribution center.

However, there are often times when one or more of the distribution centers within the network do not have enough quantity of the object to fulfil the particular request. In this case, the software application will remove these one or more distribution centers from the consideration process and only use the remaining distribution centers with available quantity to identify the optimal delivery location. Furthermore, the software application may continue to use this selected distribution center despite never analyzing the other distribution centers that do not have enough quantity to satisfy the request.

The example embodiments overcome the drawbacks noted above and provide a smart distribution network capable of identifying an optimal distribution center for a delivery of a quantity of goods to a target location even when the optimal distribution center is currently without enough quantity of the goods to satisfy a request. The system can receive an order from a customer at a target location. For example, the order may be submitted via a checkout page on a website, mobile application, database, or the like. In response to the checkout request, the host system may identify a first subset of distribution centers that currently have stock to satisfy the request, and select a distribution center from the available distribution centers. For example, the host platform may execute a predefined sourcing algorithm on performance attributes of the available distribution centers to score the distribution centers with respect to each other. The host system can select the available distribution center with the best score as the distribution center to be used to fulfill the customer request. Meanwhile, a second subset of distribution centers without enough quantity of the object to satisfy the request may be identified by the host system and removed from consideration for fulfillment.

According to various embodiments, the host system may also launch a background process that runs in the background of the website and identifies a most optimal distribution center within the distribution network for delivering the quantity of goods to the target location of the customer regardless of the current availability of the object. Here, the background process may execute the predefined sourcing algorithm on performance attributes of both the first subset of distribution centers (with enough current quantity to satisfy the request) and on performance attributes of the second subset of distribution centers which do not have enough current quantity to satisfy the request.

Furthermore, the host system may generate a copy of the quantity values at the second subset of distribution centers and change them to reflect that the second subset of distribution centers are available to satisfy the request. For any distribution center without enough quantity to satisfy the request, the host system may change the quantity value to be a bigger value (increased value) that is enough to handle the request. For example, the host system may change the quantity value to the maximum allowed value at the distribution center or some other predefined threshold. Furthermore, the predefined sourcing algorithm can be executed on the adjusted/modified values of the second subset of distribution centers and the attributes of the first subset of distribution centers to select a final optimal distribution center from among both the first subsets of distribution centers and the second subset of distribution centers.

Through the parallel process, the host system can compare the performance of the first subset of distribution centers that are available for the request and the performance of the second subset of distribution centers that are not available for the request, to identify a most optimal under “optimal circumstances” when all distribution centers are available giving the system a unique perspective on the optimal distribution location. For example, the host system may execute various KPIs on raw data from the first subset of distribution centers and the KPIs on the adjusted data from the second subset of distribution centers to select a final optimal distribution center from among both the first and second subsets of distribution centers. Here, the KPIs may determine attributes such as average delivery cost for a target location, average transportation time, number of shipments needed for the fulfillment, the total capacity of the distribution center, the available capacity of the distribution center, and the like.

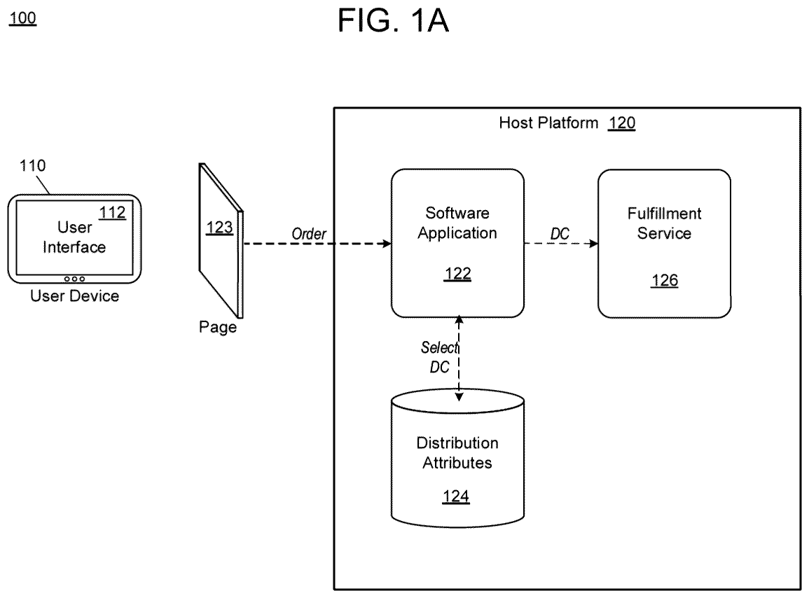

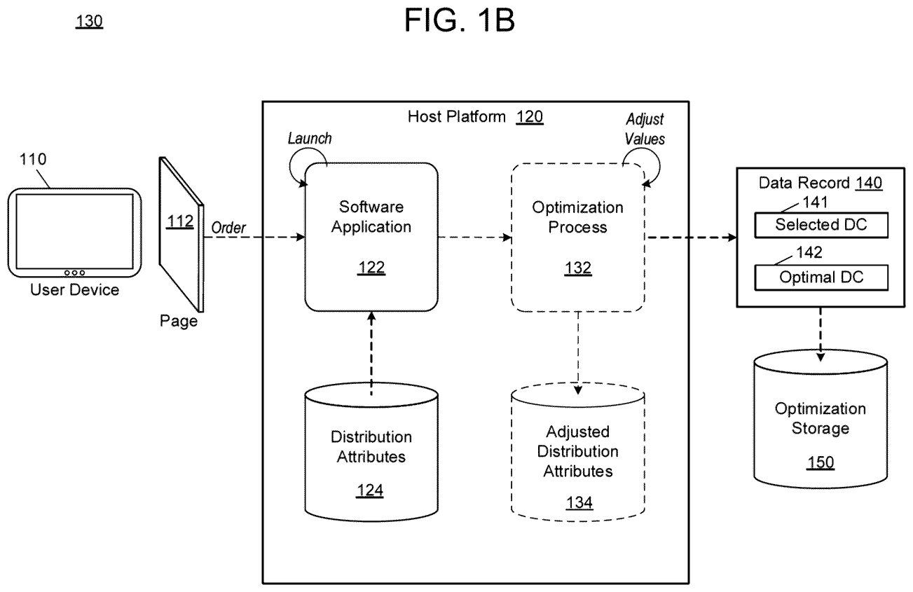

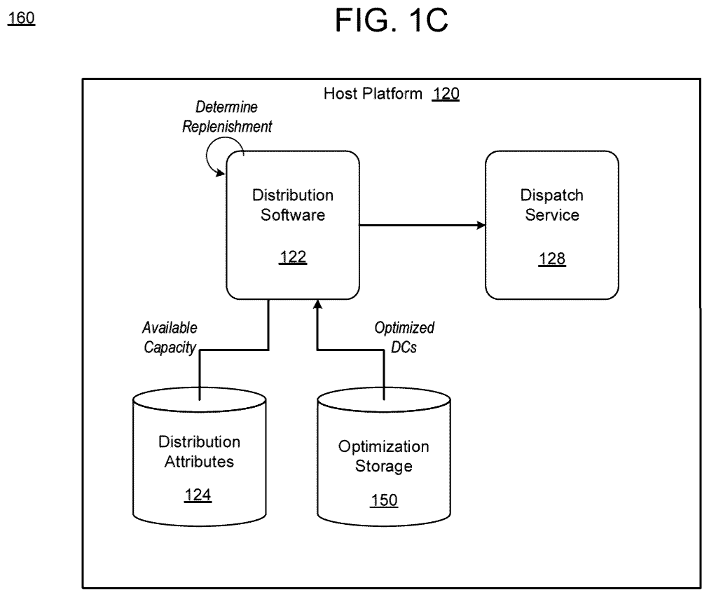

FIG. 1A illustrates a process 100 of ordering a quantity of an object via a page of a website in accordance with an example embodiment. Referring to FIG. 1A, a host platform 120 may host a software application 122 such as an e-commerce platform that enables users to purchase goods that are subsequently delivered to the user from a distribution network (also referred to as a supply network) of distribution centers. The distribution centers may be spread out over a geographic area for the purpose of providing adequate fulfillment coverage to orders from anywhere in the geographic area.

As described herein, a distribution center is typically a warehouse, building, or the like, which contains stocks of goods. Apart from storing the goods, a distribution center may also be responsible for performing additional fulfillment services such as mixing orders together, packaging, shipment, and even delivery. Distribution centers are typically designed to improve efficiency when it comes to intake, processing, storage, and distribution of goods. Another benefit of using a distribution center is that the center can fulfill larger orders with numerous different products that are readily available “on-demand” at the distribution center. In some embodiments, the distribution center may include a refrigerated storage area that enables the distribution center to satisfactorily hold perishable goods for a period of time.

According to various embodiments, a user may use a user device 110 to open a page 123 of the software application 122 on a user interface 112 of the user device 110. For example, the page 123 may be a web page, a mobile application page, a software application page, and the like. The content displayed on the page may include a checkout cart or other checkout functionality that provides the user with input commands and entry fields to place an order for a quantity of goods. The goods may be any kind of consumer goods such as those that are commonly purchased on e-commerce websites. For example, the user may enter a quantity value of a good into a field on the page 123 and press a submit button that creates a request for an order of the good in the entered quantity value with the software application 122.

In response to receiving the order, the software application 122 may identify a distribution center from among distribution centers within a distribution network that can fulfill shipment/delivery of the ordered quantity of goods. The software application 122 may determine performance attributes of a plurality of different distribution centers within a distribution network based on distribution attributes of the distribution centers which is stored in a data store 124. For example, the software application 122 may execute one or more key performance indicators (KPIs) on the distribution data from the different distribution centers to determine attributes such as transportation costs, number of shipments, available capacity, delivery time, unavailable capacity, and the like.

According to various embodiments, software application 122 may identify two subsets of distribution centers within the distribution network in response to receiving the order. For example, the software application 122 may identify a first subset of distribution centers that have enough quantity of the good to satisfy the requested order, and a second subset of distribution centers that do not have enough quantity of the good to satisfy the requested order. Here, the software application 122 can ignore the second subset of distribution centers, and select a distribution center to fulfill the shipment of the order of the good from among the first subset of distribution centers with availably quantity to satisfy the order.

For example, the software application 122 may execute a predefined sourcing algorithm on the attributes of the first subset of distribution centers to identify a best available distribution center for this particular shipment. In some embodiments, the predefined sourcing algorithm may determine to split the shipment among multiple distribution centers instead of a single distribution center. In either example, the software application 122 may trigger a fulfillment application 126 to generate a dispatch order for the goods to be sent from the best available distribution center(s) to a target location of the customer.

FIG. 1B illustrates a process 130 of determining an optimal distribution center in a background in accordance with an example embodiment. Referring to FIG. 1B, while the checkout process is being performed in the example of FIG. 1A, the host platform 120 may simultaneously initiate execution of an optimization process 132 in a background of the page 123 of the software application 122. The optimization process 132 may receive the distribution attributes of the distribution centers within the distribution network and adjust attributes in order to include more distribution centers in the optimal distribution center analysis.

For example, the optimization process 132 may adjust the quantity values of the second subset of distribution centers in the distribution attributes resulting in adjusted quantity values. In particular, the optimization process 132 may adjust the quantity values of the distribution centers in the second subset of distribution centers to have enough quantity to satisfy the order. As an example, the optimization process 132 may adjust the quantity values to be at least a predetermined fill ratio, or the like. Furthermore, the optimization process 132 may execute the KPIs on the adjusted quantity values of the second subset of distribution centers to determine adjusted performance attributes 134 of the second subset of distribution centers.

The optimization process 132 may also execute the predefined sourcing algorithm on the adjusted performance attributes 134 and the original distribution attributes of the first subset of distribution centers to identify a final optimal distribution center. In some cases, the distribution center selected to fulfill the shipment of the order may be the same distribution center that is the most optimal. However, in many cases, a different distribution center may be the more optimal, however, there is no stock of the good. In FIG. 1B, the background sourcing process is performed on simulated performance data (the adjusted performance attributes 134) resulting in a broader analysis of the distribution network. That is, the sourcing process can now analyze all of the distribution centers in the distribution network rather than just the first subset that have enough available quantity of the good.

In some embodiments, the optimization process 132 may create a data record 140 which includes an identifier 141 of the selected distribution center and an identifier 142 of the optimal distribution center, and store the data record in a storage 150. In this example, both the identifier 14 1 and the identifier 142 may be included in the data record 140 as long as the selected distribution center is different from the optimal distribution center. As another example, if the optimization process 132 determines that the optimal distribution center is the same as the selected distribution center, only one identifier may be stored in the data record.

FIG. 1C illustrates a process 160 of replenishing a distribution center within the distribution network in accordance with an example embodiment. Referring to FIG. 1C, the software application 122 may trigger a replenishment of the good at the optimal distribution center based on the optimization process 132 performed in FIG. 1A. For example, the software application 122 may transmit a dispatch notice to a dispatch service 128 with a quantity of the good to deliver to the optimal distribution center based on the analysis performed by the optimization process 132. The quantity may be determined based on attribute such as available space at the optimal distribution center, available distribution quantity, demand in the area, and the like. The dispatch service 128 may receive the order from the software application 122, and send instruction to a shipping service (not shown) which physically transports the quantity of the good to the optimal distribution center.

According to various embodiments, the optimization process performed by the optimization process 132 may be executed in parallel with the process for ordering the product performed on the page 123. Here, the optimization process may be executed simultaneously with the ordering process (e.g., in a background of the ordering process) without distracting the end user. For example, the optimization process may be executed on a first core of a multicore processor while the ordering process may be performed on a second core of the multicore processor.

In the example embodiments, the distribution network may fulfill product orders in a smarter way using existing sourcing algorithms and an optimization process that runs in a background of a webpage while an ordering process is submitted. The optimization process can assume an infinite stock of products per distribution center (or some other predefined threshold value) and identify any (e.g., one or more) distribution centers which could have been a better fit for the request had the distribution center(s) been available. The sourcing algorithm may rely on distribution attributes such as values of several KPIs including one or more of transportation costs, number of shipments to deliver the order, distribution center capacity, and delivery time.

Thus, a list of distribution centers and products ordered can be captured and saved with each order request. The list can identify any distribution centers which would have been a better fit by fulfilling all KPIs with even better scores than the current sourcing, if they would have had the goods in stock. The sourcing algorithm may generate a sourcing score according to how well the KPIs are fulfilled. For example, if the KPI goal is to have max. 4.50USD as shipment costs (which is true for the current chosen DC containing all products) and the shipment costs with the imaginary filled DC would be at 3.90USD we could score 15.38% improvement (which corresponds to a sourcing score of 1.15). The system may calculate an average sourcing score over all relevant KPIs and compare the sourcing score of the distribution centers with unlimited stock with the actual sourcing result from the selection process performed during the ordering. Furthermore, the system may store an identifier of the optimal distribution center if it has a higher sourcing score than the selected distribution center.

Some of the benefits of the example embodiments include reduced product spoilage and waste as a result of poorly managed supply chains and distribution chains. The system can also realize reduced shipping costs by strategically placing products closer to customers thereby reducing shipping distances, leading to lower transportation costs. This can result in more competitive pricing for customers. Furthermore, the example embodiments improve delivery times, lower inventory holding times, enhance product stocks held at each distribution center, improve order accuracy, reduce environmental impact, and much more.

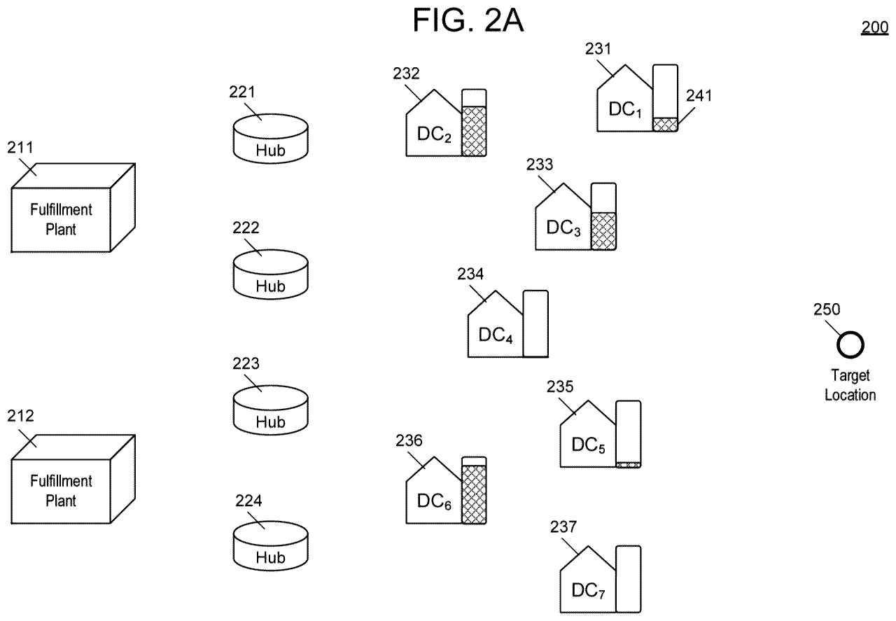

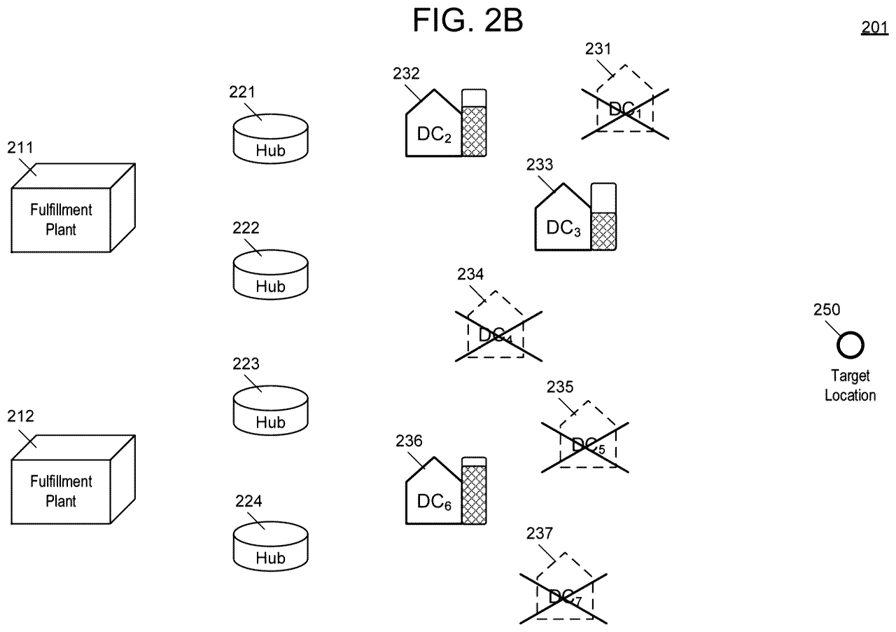

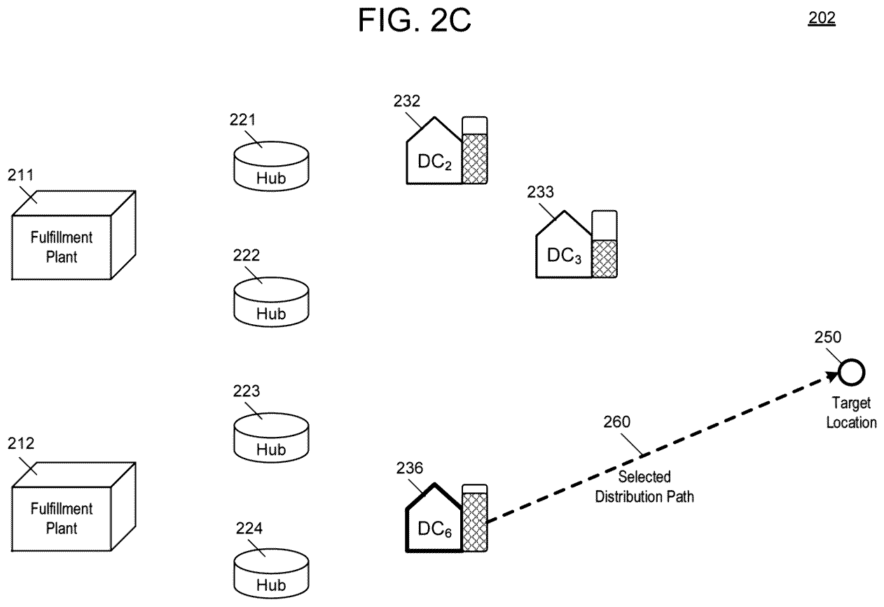

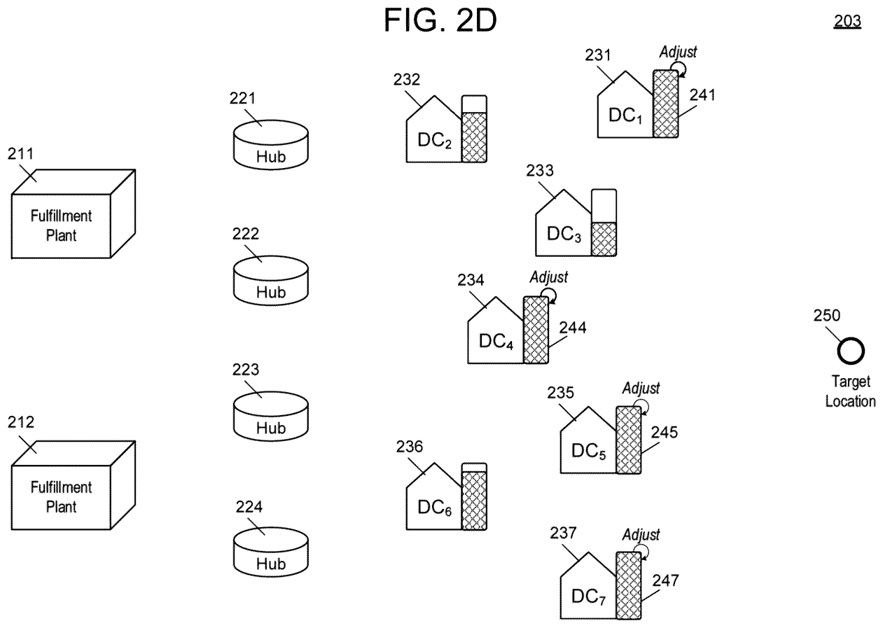

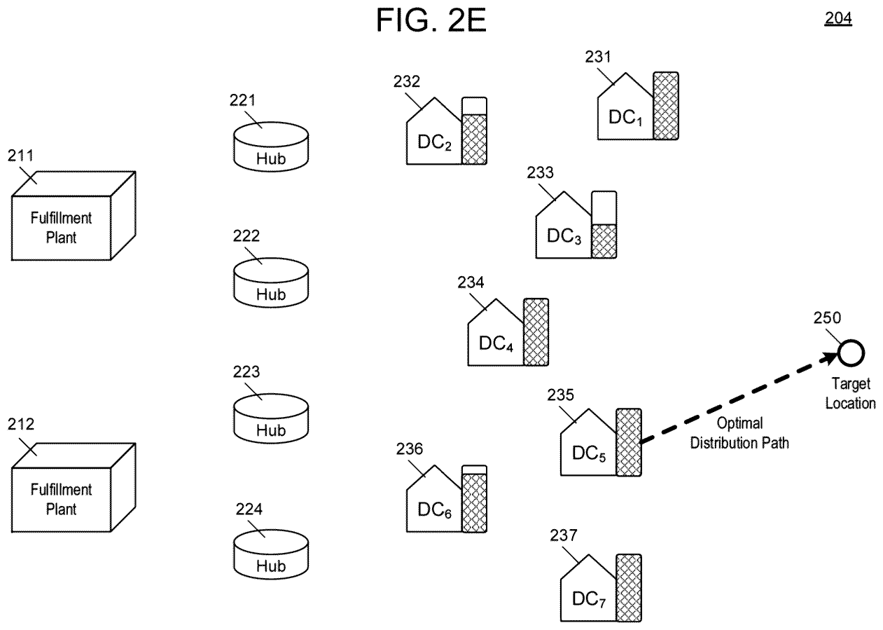

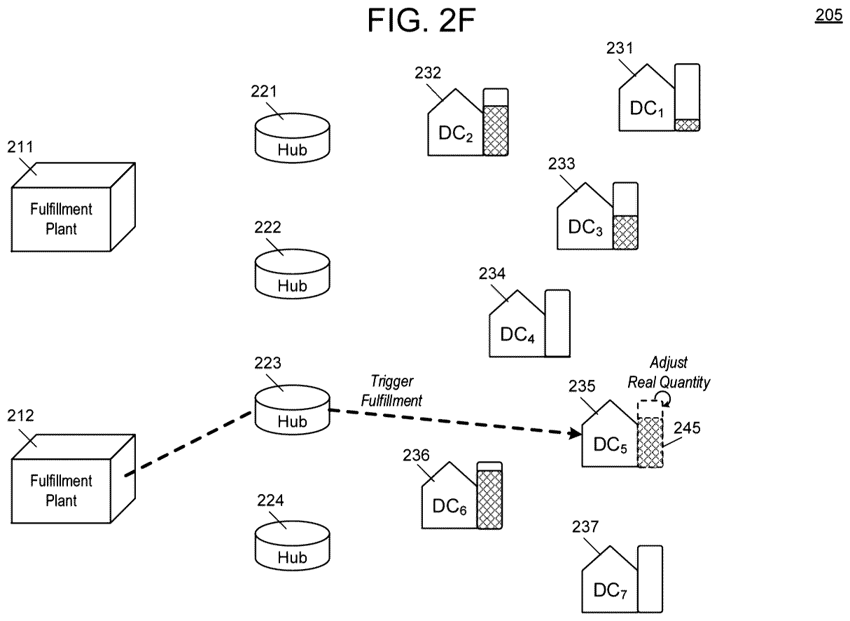

FIGS. 2A-2F illustrate a process of identifying an optimal distribution center and dispatching a quantity of goods to the optimal distribution center in accordance with example embodiments. For example, FIG. 2A illustrates a logical view 200 of a distribution network which includes a plurality of distribution centers 231, 232, 233, 234, 235, 236, and 237. The plurality of distribution centers 231, 232, 233, 234, 235, 236, and 237 receive goods delivered/shipped from fulfillment plants 211 and 212. In some cases, the distribution network may include hubs 221, 222, 223, and 224 where goods can be stored for a temporary basis between shipment from the fulfillment plants 211 and 212 to the plurality of distribution centers.

In the example of FIG. 2A, a request for an order for goods is received from a customer that is located at a target location 250. Here, the target location 250 may correspond to a geographic location of the customer where the order of goods is to be delivered. Each distribution center among the plurality of distribution centers 231, 232, 233, 234, 235, 236, and 237 may be located at a different geographic location.

FIG. 2B illustrates a process 201 of identifying distribution centers that have enough quantity to satisfy the order for goods at the target location 250. In this example, the software application may read current quantity values of the good at the plurality of distribution centers 231, 232, 233, 234, 235, 236, and 237 from a storage device such as a database or other storage. In this example, the software identifies a first subset of distribution centers 232, 233, and 236 have enough current quantity of the good to satisfy the quantity of the good included in the order. Meanwhile, a second subset of distribution centers 231, 234, 235, and 237 do not have enough quantity of the good to satisfy the order.

According to various embodiments, the software application may ignore the second subset of distribution centers 231, 234, 235, and 237 when selecting a distribution center to fulfill the order to the target location 250. For example, FIG. 2C illustrates a process 202 of identifying a best available distribution center 236 from among the first subset of distribution centers 232, 233, and 236 via execution of a predefined sourcing algorithm on performance attributes (e.g., KPI values, etc.) of the first subset of distribution centers 232, 233, and 236. For example, the predefined sourcing algorithm may be executed by the software application on current quantity values that are read from a database. According, a fulfillment path 260 is selected and used to fulfill the order. For example, the software may dispatch a shipment order to a transportation service which moves the goods from the distribution center 236 to the target location 250 in the physical world.

According to various embodiments, as the software is performing the processes 201 and/or 202, the software application may also launch an optimization process. The optimization process may identify an optimal distribution center from among all possible distribution centers and if a better distribution center (e.g., better sourcing score, etc.) than the selected distribution center is found, the optimization process may store an identifier of the more optimal distribution center within a storage device. Furthermore, if multiple more optimal distribution centers are found, identifiers of the multiple more optimal distribution centers may be stored. As another example, the identifier of the more optimal distribution center(s) may be stored on the sales order and held in storage for subsequent analysis.

For example, FIG. 2D illustrates a process 203 of adjusting quantity values of the second subset of distribution centers 231, 234, 235, and 237 to have enough quantity to satisfy the quantity of goods in the requested order. As an example, the software application may adjust the quantity values to a maximum allowed capacity or another predetermined ratio. In this example, the software application adjust a quantity value 241 of a distribution center 231 to a maximum allowed value, a quantity value 244 of a distribution center 234 to a maximum allowed capacity value, a quantity value 245 of a distribution center 235 to a maximum allowed capacity value, and a quantity value 247 of a distribution center 237 to a maximum allowed capacity value. The values may be adjusted in a storage device that is used to temporarily store the adjusted values such as a RAM, flash drive, etc.

FIG. 2E illustrates a process 204 of identifying an optimal distribution center based on the adjusted quantity values generated in the process 203 of FIG. 2D. In this example, the software application may execute the predefined sourcing algorithm on the distribution attributes (e.g., KPIs, etc.) of the second subset of distribution centers (i.e., the distribution centers 231, 234, 235, and 237) including the adjusted quantity values. Thus, each of the distribution centers in the second subset of distribution centers 231, 234, 235, and 237 may be scored and compared to the scores assigned to the first subset of distribution centers 232, 233, and 236, to identify a most optimal distribution center 235 from among the plurality of distribution centers 231, 232, 233, 234, 235, 236, and 237. An identifier of the most optimal distribution center 235 may be added to the sales order which already includes the selected distribution center 236.

The optimization process described herein may be performed on an iterative basis resulting in a large corpus of data records that include more optimal distribution centers than which were selected. The software application may execute algorithms on the data to identify different distribution centers where the product/goods should be stored in order to better handle the current demand of the network. For example, FIG. 2F illustrates a process 205 of determining a future fulfillment path for the same order received in FIG. 2A In this example, the software application orders a replenishment of a quantity of goods to the most optimal distribution center 235 based on the optimization process and the analysis performed. The result is that the quantity value 245 at the most optimal distribution center 235 increases in storage and in the physical world, and can thus be used to handle orders more efficiently in the future.

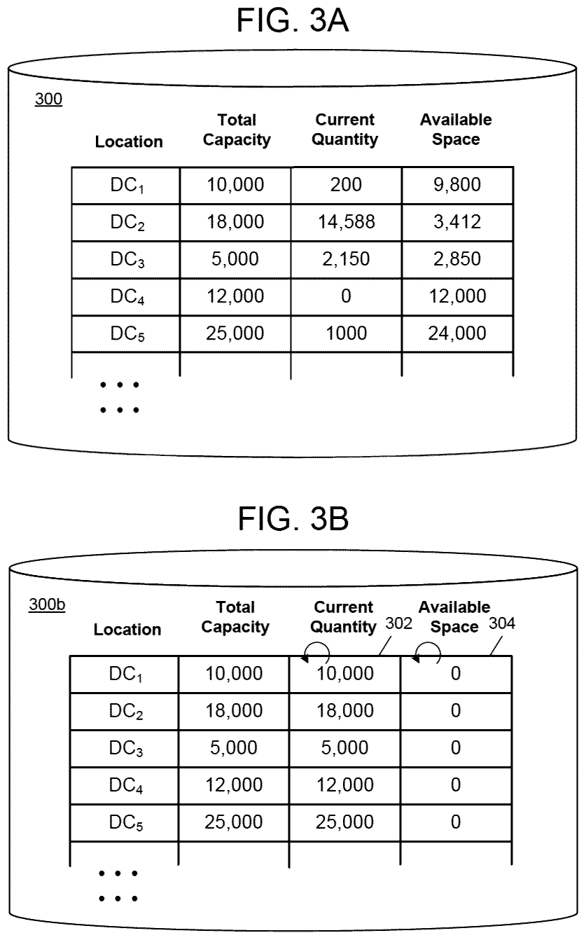

FIGS. 3A and 3B illustrate a process of adjusting table data to identify the optimal distribution center within the supply network in accordance with an example embodiment. For example, FIG. 3A illustrates a table 300 with a plurality of values of current quantity values of a plurality of distribution centers within the distribution network. Here, the table 300 includes separate columns for location, total capacity, current quantity, and available capacity. However, it should be appreciated that these distribution attributes are may be different data depending on implementation.

In the example of FIG. 3A, attributes of five different distribution centers within a common distribution network are shown. Here, a request may be received for a quantity of an object, such as a product, good, etc. The table includes a column 302 that identifies a current quantity of the product held at each distribution center and a column 304 that identifies an amount of product that can be stored at the distribution center. Here, there are multiple DCs that cannot satisfy the requested quantity including DC₁ and DC₄ which each have zero quantity of product available. The table 300 may be used to select an available distribution center from among the available distribution centers with enough quantity of product.

Meanwhile, FIG. 3B illustrates a modified table 300b that is modified by the optimization process 132 that is shown in FIG. 1B. Here, the modified table 300b is generated by adjusting/increasing the quantity values in the column 302 to generate a modified column 302b of data values such that each DC has enough quantity to satisfy a request for the product. Here, the system increases the values in the modified column 302b to a maximum amount held or another predefined amount. The modified table 300b can be used to determine an optimal distribution center from among all possible distribution centers including those distribution centers which do not have enough quantity to satisfy a requested amount of product at checkout.

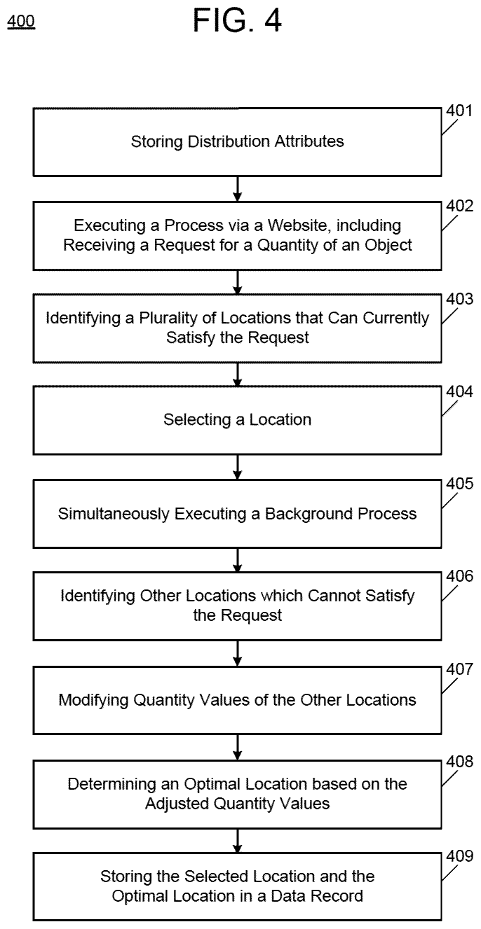

FIG. 4 illustrates a method 400 of determining optimal fulfillment instructions based on background sourcing process in accordance with an example embodiment. For example, the method 400 may be executed by a host platform such as a server, a cloud platform, a user device, a software program, a combination thereof, and the like. Referring to FIG. 4, in 401, the method may include storing distribution attributes of geographic locations in a storage device. In 402, the method may include executing a process via a page of a website, wherein the execution of the process comprises identifying a quantity of a physical object for a target geographic location. In 403, the method may include identifying a plurality of different geographic locations where the quantity of the physical object is currently located based on data records stored within a storage device. In 404, the method may include selecting a location from among the plurality of different geographic locations via execution of a predefined algorithm on attributes of the different geographic locations.

According to various embodiments, in 405, the method may include executing a background process simultaneously with execution of the process. In 406, the method may include identifying other geographic locations which do not have enough quantity of the physical object to satisfy the quantity for the target location. In 407, the method may include adjusting the quantity values of the physical object at the other geographic locations in the storage device to satisfy the request. In 408, the method may include determining an optimal geographic location from among the plurality of different geographic locations and the other geographic locations based on the adjusted quantity values of the physical object in the storage device. In 409, the method may include storing a record that comprises the optimal geographic location and the selected geographic location in the storage device.

In some embodiments, the executing the background process may include starting execution of the background process in response to a user inputting commands into a user interface of the page of the website. In some embodiments, the executing the process may include executing the process on a first core of a multicore process and the executing the background process comprises executing the background process via a second core of the multicore processor.

In some embodiments, the method may further include executing the predefined algorithm based on distribution attributes of the optimal geographic location and distribution attributes of the selected geographic location to generate a value for the optimal geographic location and to generate a value for the selected geographic location. In some embodiments, the method further comprises determining that the value for the optimal geographic location is greater than the value for the selected geographic location, and in response to the determination, storing the record that comprises the optimal geographic location and the selected geographic location in the storage device.

In some embodiments, the method may further include triggering a delivery of the physical object from the selected geographic location to the target location, and triggering a replenishment of the physical object at the optimal geographic location instead of the selected geographic location. In some embodiments, the method may further include executing database operations on table data associated with the physical object in the storage device to adjust the quantity values of the physical object at the other geographic locations in the storage device, prior to determination of the optimal geographic location. In some embodiments, the method may further include executing key performance indicators (KPIs) on runtime data from the geographic locations to generate the distribution attributes of the geographic locations.

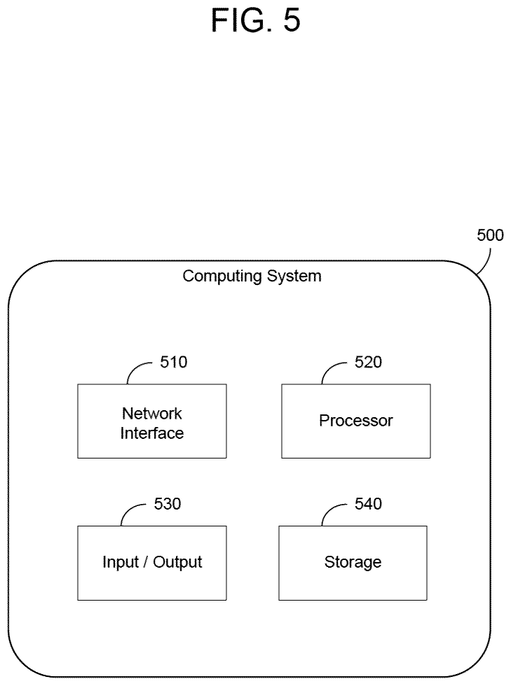

FIG. 5 illustrates a computing system 500 that may be used in any of the methods and processes described herein, in accordance with an example embodiment. For example, the computing system 500 may be a database node, a server, a cloud platform, or the like. In some embodiments, the computing system 500 may be distributed across multiple computing devices such as multiple database nodes. Referring to FIG. 5, the computing system 500 includes a network interface 510, a processor 520, an input/output 530, and a storage 540 such as an in-memory storage, and the like. Although not shown in FIG. 5, the computing system 500 may also include or be electronically connected to other components such as a display, an input unit(s), a receiver, a transmitter, a persistent disk, and the like. The processor 520 may control the other components of the computing system 500.

The network interface 510 may transmit and receive data over a network such as the Internet, a private network, a public network, an enterprise network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The input/output 530 may include an interface, a port, a cable, a bus, a board, a wire, and the like, for inputting and outputting data to and from the computing system 500. For example, data may be output to an embedded display of the computing system 500, an externally connected display, a display connected to the cloud, another device, and the like. The network interface 510, the input/output 530, the storage 540, or a combination thereof, may interact with applications executing on other devices.

The storage 540 is not limited to a particular storage device and may include any known memory device such as RAM, ROM, hard disk, and the like, and may or may not be included within a database system, a cloud environment, a web server, or the like. The storage 540 may store software modules or other instructions which can be executed by the processor 520 to perform the methods described herein. According to various embodiments, the storage 540 may include a data store having a plurality of tables, records, partitions and sub-partitions. The storage 540 may be used to store database records, documents, entries, and the like. As another example, the storage 540 may include a code repository that is configured to store source code files of computer programs including APIs.

According to various embodiments, the storage 540 may store distribution attributes of various distribution centers within a distribution network. The attributes may be generated by executing key performance indicators (KPIs) on table data stored in the storage 540. The attributes may include average delivery times, transportation costs, number of shipments needed to fulfill the order, a storage capacity, and the like.

According to various embodiments, the processor 520 may execute a process via a page of a website. The execution of the process may include identifying a quantity of a physical object for a target geographic location. The processor 520 may identify a plurality of different geographic locations where the quantity of the physical object is currently located based on data records stored within the storage 540. The processor 520 may select a location from among the plurality of different geographic locations via execution of a predefined algorithm on attributes of the different geographic locations. The processor 520 may execute a background process simultaneously with execution of the process.

During the execution of the background process, the processor 520 may identify other geographic locations in the storage device which do not have enough quantity of the physical object to satisfy the quantity for the target location. The processor 520 may adjust the quantity values of the physical object at the other geographic locations in the storage 540 to satisfy the request. The processor 520 may determine an optimal geographic location from among the plurality of different geographic locations and the other geographic locations based on the adjusted quantity values of the physical object in the storage 540. The processor 520 may store a record that comprises the optimal geographic location and the selected geographic location in the storage 540.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), cloud storage, and the like.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a memory configured to store distribution attributes of geographic locations; and
a processor configured to
execute a process via a page of a website, wherein the execution of the process comprises receiving a request for a quantity of a physical object for a target geographic location,
identify a plurality of different geographic locations where the quantity of the physical object is currently located based on data records stored within a storage device;
select a location from among the plurality of different geographic locations via execution of a predefined algorithm on attributes of the different geographic locations,
execute a background process simultaneously with execution of the process, wherein, during execution of the background process, the processor is configured to:
identify other geographic locations which do not have enough quantity of the physical object to satisfy the quantity for the target location from the storage device;
adjust quantity values of the physical object at the other geographic locations in the storage device to satisfy the request, and
determine an optimal geographic location from among the plurality of different geographic locations and the other geographic locations based on the adjusted quantity values of the physical object in the storage device, and
store a record that comprises the optimal geographic location and the selected geographic location in the storage device.

2. The computing system of claim 1, wherein the processor is configured to start execution of the background process in response to a user inputting commands into a user interface of the page of the website.

3. The computing system of claim 1, wherein the processor is a multicore processor, and the processor is configured to execute the process of the website via a first core of the multicore processor and execute the background process via a second core of the multicore processor.

4. The computing system of claim 1, wherein the processor is configured to execute the predefined algorithm based on distribution attributes of the optimal geographic location and distribution attributes of the selected geographic location to generate a value for the optimal geographic location and to generate a value for the selected geographic location.

5. The computing system of claim 4, wherein the processor is configured to determine that the value for the optimal geographic location is greater than the value for the selected geographic location, and in response to the determination, store the record that comprises the optimal geographic location and the selected geographic location in the storage device.

6. The computing system of claim 1, wherein the processor is configured to trigger a delivery of the physical object from the selected geographic location to the target location, and trigger a replenishment of the physical object at the optimal geographic location instead of the selected geographic location.

7. The computing system of claim 1, wherein the processor is configured to execute database operations on table data associated with the physical object in the storage device to adjust the quantity values of the physical object at the other geographic locations in the storage device, prior to determination of the optimal geographic location.

8. The computing system of claim 1, wherein the processor is further configured to execute key performance indicators (KPIs) on runtime data from the geographic locations to generate the distribution attributes of the geographic locations.

9. A method comprising:
storing distribution attributes of geographic locations in a storage device;
executing a process via a page of a website, wherein the execution of the process comprises receiving a request for a quantity of a physical object for a target geographic location;
identifying a plurality of different geographic locations where the quantity of the physical object is currently located based on data records stored within a storage device;
selecting a location from among the plurality of different geographic locations via execution of a predefined algorithm on attributes of the different geographic locations; and
executing a background process simultaneously with execution of the process, wherein execution of the background process comprises:
identifying other geographic locations which do not have enough quantity of the physical object to satisfy the quantity for the target location from the storage device;
adjusting quantity values of the physical object at the other geographic locations in the storage device to satisfy the request, and
determining an optimal geographic location from among the plurality of different geographic locations and the other geographic locations based on the adjusted quantity values of the physical object in the storage device, and
storing a record that comprises the optimal geographic location and the selected geographic location in the storage device.

10. The method of claim 9, wherein the executing the background process comprises starting execution of the background process in response to a user inputting commands into a user interface of the page of the website.

11. The method of claim 9, wherein the executing the process comprises executing the process on a first core of a multicore processor and the executing the background process comprises executing the background process via a second core of the multicore processor.

12. The method of claim 9, wherein the method further comprises executing the predefined algorithm based on distribution attributes of the optimal geographic location and distribution attributes of the selected geographic location to generate a value for the optimal geographic location and to generate a value for the selected geographic location.

13. The method of claim 12, wherein the method further comprises determining that the value for the optimal geographic location is greater than the value for the selected geographic location, and in response to the determination, storing the record that comprises the optimal geographic location and the selected geographic location in the storage device.

14. The method of claim 9, wherein the method further comprises triggering a delivery of the physical object from the selected geographic location to the target location, and triggering a replenishment of the physical object at the optimal geographic location instead of the selected geographic location.

15. The method of claim 9, wherein the method further comprises executing database operations on table data associated with the physical object in the storage device to adjust the quantity values of the physical object at the other geographic locations in the storage device, prior to determination of the optimal geographic location.

16. The method of claim 9, wherein the method further comprises executing key performance indicators (KPIs) on runtime data from the geographic locations to generate the distribution attributes of the geographic locations.

17. A computer-readable storage medium comprising instructions which when executed by a processor cause a computer to perform:
storing distribution attributes of geographic locations in a storage device;
executing a process via a page of a website, wherein the execution of the process comprises receiving a request for a quantity of a physical object for a target geographic location;
identifying a plurality of different geographic locations where the quantity of the physical object is currently located based on data records stored within a storage device;
selecting a location from among the plurality of different geographic locations via execution of a predefined algorithm on attributes of the different geographic locations; and
executing a background process simultaneously with execution of the process, wherein execution of the background process comprises:
identifying other geographic locations in the storage device which do not have enough quantity of the physical object to satisfy the quantity for the target location;
adjusting quantity values of the physical object at the other geographic locations in the storage device to satisfy the request, and
determining an optimal geographic location from among the plurality of different geographic locations and the other geographic locations based on the adjusted quantity values of the physical object in the storage device, and
storing a record that comprises the optimal geographic location and the selected geographic location in the storage device.

18. The computer-readable storage medium of claim 17, wherein the executing the background process comprises starting execution of the background process in response to a user inputting commands into a user interface of the page of the website.

19. The computer-readable storage medium of claim 17, wherein the executing the process comprises executing the process on a first core of a multicore processer and the executing the background process comprises executing the background process via a second core of the multicore processor.

20. The computer-readable storage medium of claim 17, wherein the method further comprises executing the predefined algorithm based on distribution attributes of the optimal geographic location and distribution attributes of the selected geographic location to generate a value for the optimal geographic location and to generate a value for the selected geographic location.
